(19) United States
(12) Patent Application Publication
(10) Pub. No.: US 2025/0289301 A1
(43) Pub. Date: Sep. 18, 2025

(54) SUPPORT STRUCTURE FOR ELECTRIC VEHICLE BATTERY, ASSEMBLY WITH THE SAME, AND METHODS OF MANUFACTURING, INTEGRATING, AND USING THE SAME

(71) Applicant: Daimler Truck North America LLC, Portland, OR (US)

(72) Inventors: Ian GREEN, Portland, OR (US); Trevor TAKARO, Battle Ground, WA (US); Eric John CARLSON, Portland, OR (US); Walter PRATT, Portland, OR (US)

(21) Appl. No.: 18/868,136

(22) PCT Filed: May 31, 2023
(86) PCT No.: PCT/US2023/024042

§ 371 Date: Nov. 21, 2024

Related U.S. Application Data
(60) Provisional application No. 63/347,297, filed on May 31, 2022.

(51) Int. Cl. B60K 1/04; H01M 50/242; H01M 50/249; H01M 50/264

(52) U.S. Cl. CPC B60K 1/04; H01M 50/242; H01M 50/249; H01M 50/264; B60K 2001/0438

(57) ABSTRACT

Embodiments herein relate to a battery support structure for an electric vehicle, assemblies with the same, and methods of manufacturing, integrating, and using the same, among other things. In embodiments, a support structure for use on an electric vehicle includes a pair of frame rails and a battery case with a bottom coupled to the frame rails. The battery case is coupled to the frame rails at a location below the frame rails, e.g., with resilient bushings held between the battery case and the frame rails by brackets extending below the frame rails, and away from the battery case.

### FIELD OF THE INVENTION

Embodiments herein relate to a support structure for a battery, and more particularly to a frame rail and a battery case that support an isolated structural battery or battery assembly mounted on an electric vehicle.

### BRIEF DESCRIPTION OF THE DRAWING

Embodiments of the present disclosure are described in detail below with reference to the attached drawing figures, wherein:

FIG. 1 depicts a front perspective view of a support structure for an electric vehicle, in accordance with embodiments of the present disclosure;

FIG. 2 depicts a rear perspective view of the support structure of FIG. 1, in accordance with embodiments of the present disclosure;

FIG. 3 depicts an enlarged perspective view of the encircled region 3 identified in FIG. 1, in accordance with embodiments of the present disclosure;

FIG. 4 depicts an enlarged partial rear perspective view of the support structure shown in FIG. 2, in accordance with embodiments of the present disclosure;

FIG. 5 depicts a partially exploded side view of the support structure shown in FIG. 1, in particular depicting a battery case separated from a pair of frame rails, in accordance with embodiments of the present disclosure; and

FIG. 6 depicts an example vehicle incorporating the support structure shown in FIG. 1, in accordance with embodiments of the present disclosure; and

FIG. 7 is a block diagram of a method of integrating a support structure into a vehicle, in accordance with embodiments of the present disclosure.

### DETAILED DESCRIPTION OF THE INVENTION

The subject matter of this disclosure is described with specificity herein to meet statutory requirements. However, the description itself is not intended to limit the scope of the invention. Rather, it is contemplated that the claimed or disclosed subject matter might also be embodied in other ways, to include different steps, different combinations of steps, different features, and/or different combinations of features, similar to those described in this document, in conjunction with other present or future technologies and/or solutions.

Vehicles, e.g., electric vehicles or at least partially electric vehicles, typically have a frame structure and at least one battery or battery assembly used to power one or more electrical components and/or systems of the vehicle, e.g., electric motors and related components. The frame structure typically includes a pair of spaced apart frame or chassis rails. The battery assembly is typically a case structure or other enclosure that is adapted to support one or more battery cells, packs, stacks, or other battery components. To increase the range of such vehicles, it is desirable to provide additional battery capacity, and this as a result, can require a larger battery case. There is thus a need to have a frame structure that supports a large capacity battery or battery assembly, while at the same time limiting the overall weight of the frame structure, and protecting the battery case (and thus the battery cells) from loads and forces experienced by the frame structure during normal use. Further, there is a need for a frame structure that maintains the ability to support a vehicle even with a battery case removed (e.g., for maintenance or servicing).

In brief, and at a high level, embodiments herein relate to a support structure for an electric vehicle that may include a pair of elongated frame rails that are spaced apart from one another. Each frame rail has a front end and a rear end. In embodiments, at least one battery case that has at least a front wall, a rear wall and a bottom is coupled to the rails at a point below the frame rails. The support structure can further include a first coupling structure, extending between the front wall of the battery case and the pair of elongated frame rails; and a second coupling structure, extending between the rear wall of the battery case and the pair of elongated frame rails. The first coupling structure and the second coupling structure secure the battery case at least partially below the frame rails. In embodiments, the first coupling structure comprises: a pair of spaced apart front rail brackets, each having a first end coupled to a respective frame rail and a second end extending downwardly therefrom, a pair of front battery brackets coupled to the front wall of the battery case and extending forwardly therefrom; and a pair of front bushings, each front bushing coupled to and extending between a respective second end of a front rail bracket and a respective front battery bracket, wherein the front bushings establish a mounting point for the battery case to the frame rail that is below the frame rail. In embodiments, each front bushing can include a resilient inner core. Similarly, in some embodiments, the second coupling structure comprises: a pair of spaced apart rear rail brackets, each having a first end coupled to a respective frame rail and a second end extending downwardly therefrom, a pair of rear battery brackets coupled to the rear wall of the battery case and extending rearwardly therefrom; and a pair of rear bushings, each rear bushing coupled to and extending between a respective second end of a rear rail bracket and a respective rear battery bracket, such that the rear bushings establish a mounting point for the battery case to the frame rail that is at least partially below the frame rail. In embodiments, each rear bushing can have a resilient inner core. Further, in some embodiments, in the support structure, at least one of the front bushings or the rear bushings are molded to provide greater resiliency in at least one direction. Also, in some embodiments, each frame rail is an elongated member having a height, and wherein the height of each frame rail is less in the portion of each frame rail above the battery case, and wherein the height of the frame rail is more in the portion of each frame rail extending forwardly and rearwardly from the footprint of the battery case.

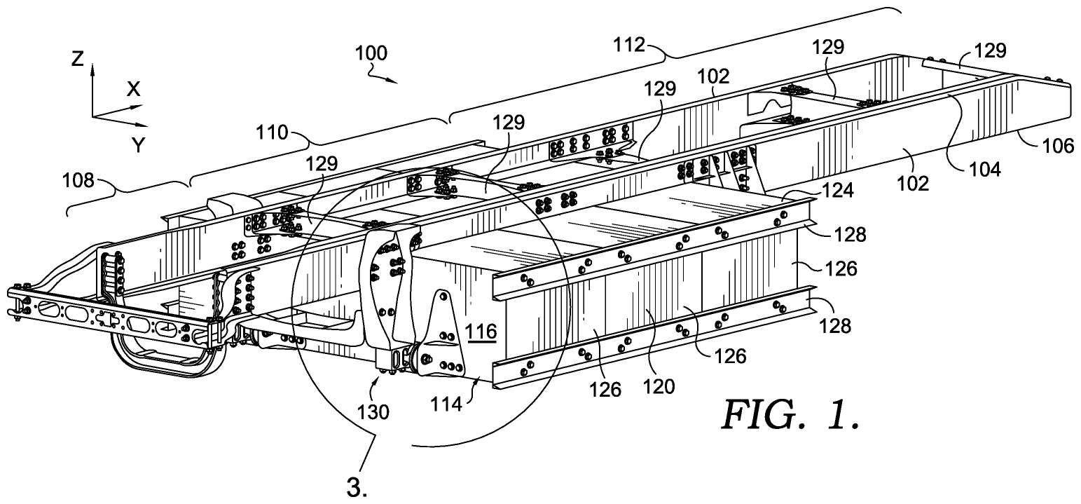

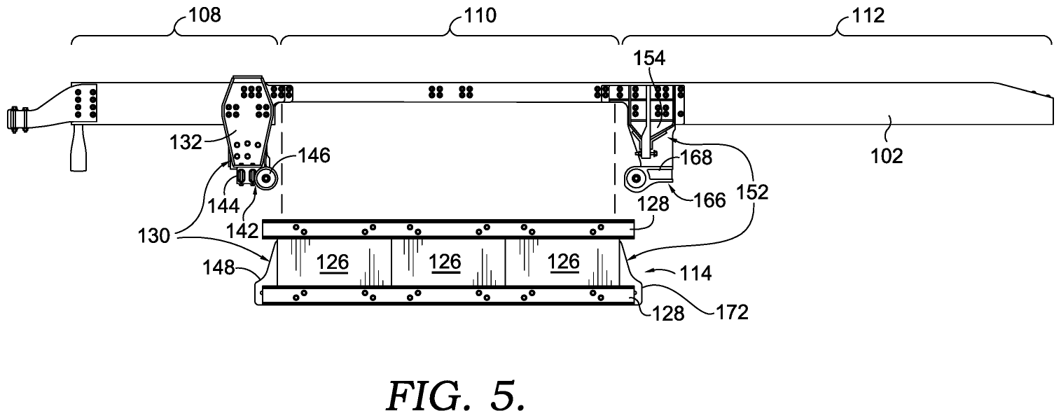

Looking now at FIG. 1, a support structure 100 that can be integrated into a vehicle, e.g., an electrically-powered vehicle, e.g., an electric truck, is shown, in accordance with embodiments of the present disclosure. The support structure 100 includes a pair of elongated frame rails 102 that are spaced apart from one another. In some embodiments, the frame rails 102 may be constructed from metal, metal alloys, and/or composites, e.g., in one embodiment being formed from high-strength steel. The frame rail 102 has a top 104 and a bottom 106, with a height extending between the top 104 and the bottom 106. The frame rail 102 also has a forward section 108, a middle section 110, and a rear section 112. In embodiments, the frame rail 102 can be formed as an integral one-piece unified structure or part. Or, in embodiments, the frame rail 102 may be formed from multiple pieces that are assembled together and fixedly coupled to each other. In some embodiments, e.g., as seen in FIG. 5, the middle section 110 is shorter in height than the forward section 108 and the rear section 112. It should also be understood that there is no exact delineation between the forward section 108, the middle section 110, and the rear section 112, and these portions are identified generally for discussion purposes.

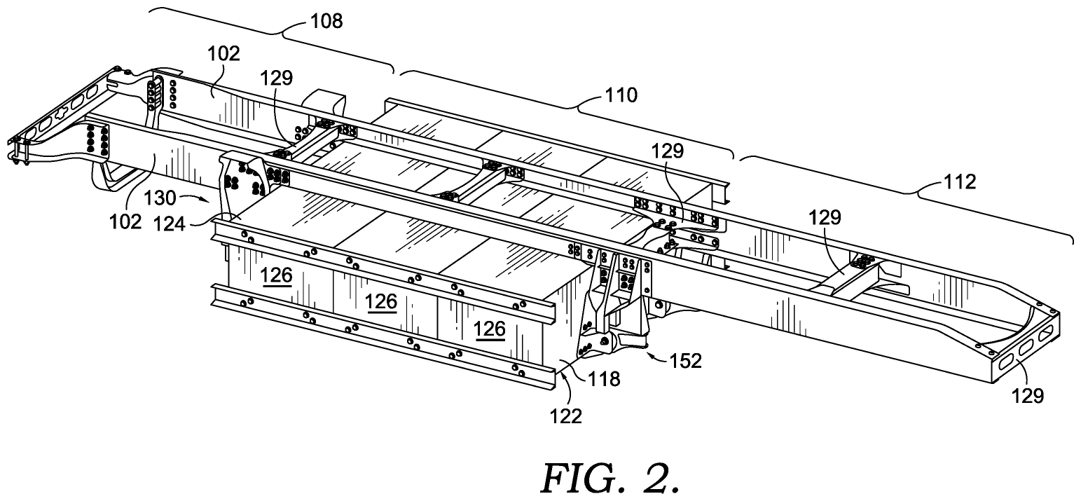

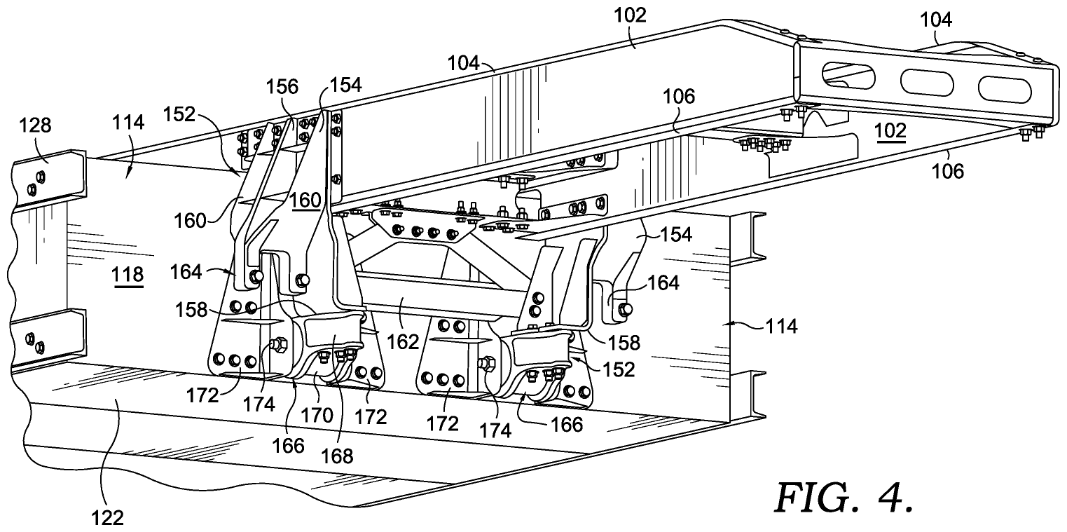

Looking still at FIG. 1, the support structure 100 also includes a battery case 114. The battery case 114 is formed to at least partially house and/or enclose a number of battery cells and has a front wall 116, a rear wall 118 (as seen in FIGS. 2 and 4), a pair of side walls 120 extending between the front wall 116 and the rear wall 118, and also includes a bottom 122 and a top 124. In some embodiments, the bottom 122 has a higher structural integrity (e.g., rigidity and/or strength) than the top 124. In some embodiments, the battery case 114 is located below the middle section 110 (and thus below the portion of the frame rail 102 having a shorter height than other portions of the frame rail 102 as shown in FIGS. 1 and 2). The battery case 114 may include one or more battery packs 126. FIGS. 1-5 show three battery packs 126 fixedly coupled to one another. However, in embodiments, more or fewer are contemplated. In some embodiments, a coupling strap 128 is fixedly coupled to the side walls 120 to bridge the battery packs 126 together, effectively forming one larger battery case, assembly, and/or enclosure represented as battery case 114 that is represented only for example purposes. It should be understood that while three battery packs 126 are shown in FIG. 1, more, or fewer, battery packs could be utilized within support structure 100. In addition, as the size of the battery case 114 changes, the length of the middle section 110 of the frame rails 102 may change correspondingly. As best seen in FIGS. 1 and 2, the support structure 100 may include a number of cross-supports 129 coupled to, and extending between, the pair of frame rails 102, spaced along the frame rails 102 in the longitudinal direction (along the X-axis labeled in FIG. 1). This direction can correspond to the longitudinal direction of a vehicle, e.g., a direction extending between a vehicle front end and a vehicle rear end, e.g., along an axis of a traditional drive shaft.

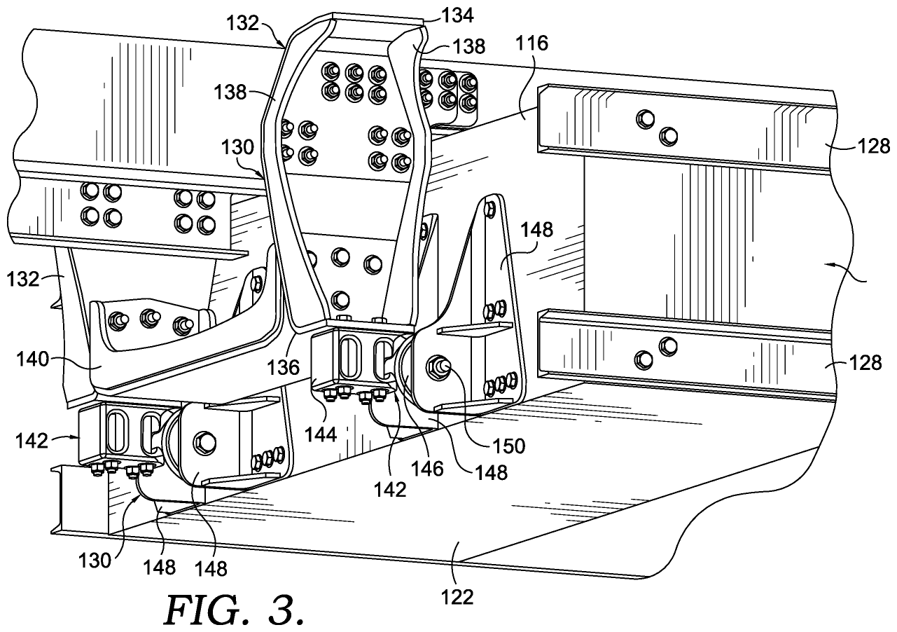

As best seen in FIGS. 1 and 3, a coupling structure 130 is used to couple the battery case 114 to the frame rails 102. More specifically, the coupling structure 130 couples the front wall 116 of the battery case 114 to the frame rails 102 proximate to the transition from the forward section 108 to the middle section 110. In embodiments, the coupling structure 130 includes a pair of front rail brackets 132 that each have a first end 134 fixedly coupled to a corresponding frame rail 102, e.g., using fasteners (e.g., bolts or other fastener components). Each front rail bracket 132 has a second end 136 below, and distal from, the first end 134. In embodiments, the front rail brackets 132 have side flanges 138 that impart additional strength to the front rail brackets 132. In embodiments, the front rail brackets 132 can be aluminum, steel, or cast iron drop castings. As best seen in FIG. 3, a cross-member 140 may be coupled to, and extend between, the pair of front rail brackets 132 proximate to the second ends 136.

The coupling structure 130 can include, in some embodiments, a bushing 142. Each bushing 142 may have a mounting arm 144 that is fixedly coupled to the second end 136 of a respective front rail bracket 132, such that it extends below the second end 136. The bushing 142 may also include, in some embodiments, a resilient core 146. The resilient core may be formed of a material and/or construction that is suitable for providing a degree of elasticity, dissipating energy, and/or reducing transient forces such as vibrations. Each resilient core 146 is coupled to a corresponding front battery bracket 148. In embodiments, each front battery bracket 148 can be fixedly coupled to the front wall 116 of the battery case 114, or can be fixedly coupled to the front wall 116 through one or more interposed structures. In some embodiments, the resilient core 146 can be resilient substantially equally in all directions, and in other embodiments, the resilient core 146 can have greater resiliency in certain directions to better distribute loads. As best seen in FIG. 3, the front battery bracket 148 has a left side and a right side, with the bushing 142 held between the left side and the right side, such as with a bolt 150. As is discussed further below, the coupling structure 130 couples the front wall 116 of the battery case 114 to the frame rail 102 at an effective coupling point below the frame rail 102, and in some embodiments, proximate to the bottom 122 of the battery case 114 (e.g., at the location of bolt 150).

Looking at FIGS. 2 and 4, another coupling structure 152 is shown. The coupling structure 152 is used to couple the battery case 114 to the frame rails 102. More specifically, the coupling structure 152 couples the rear wall 118 of the battery case 114 to the frame rails 102 proximate the transition between the middle section 110 and the rear section 112. In some embodiments, the coupling structure 152 includes a pair of rear rail brackets 154 that have a first end 156 fixedly coupled to the frame rail 102 e.g., using fasteners (e.g., bolts or other fastener components). Each rear rail bracket 154 has a second end 158 below, and distal from, the first end 156. In some embodiments, the rear rail brackets 154 have side flanges 160 that can provide additional strength to the rear rail brackets 154. In some embodiments, the rear rail brackets 154 can be aluminum, steel, or cast iron drop castings. As best seen in FIG. 4, a cross-member 162 may be coupled to, and extend between, the pair of rear rail brackets 154 proximate to the second ends 158. As best seen in FIG. 4, in some embodiments, each rear rail bracket 154 may have an integrally formed spring mounting section 164 that is used to mount suspension springs to the support structure 100. In some embodiments, the front structure (such as the front rail brackets 132) may be similarly constructed to include a spring or suspension control rod/arm mount.

The coupling structure 152 further includes, in some embodiments, a bushing 166. Each bushing 166 may have a mounting arm 168 that is fixedly coupled to the second end 158 of a respective rear rail bracket 154, such that it extends below the second end 158. The bushing 166 may also have, in some embodiments, a resilient core 170, similar to those described in connection with FIGS. 1 and 3. The resilient core 170 is coupled to a corresponding rear battery bracket 172. In embodiments, the rear battery bracket 172 can be fixedly coupled to the rear wall 118 of the battery case 114, or can be coupled to the rear wall 118 through one or more interposed structures. In some embodiments, the resilient core 170 can be resilient substantially equally in all directions, and in other embodiments, the resilient core has greater resiliency in certain directions to better distribute loads. In some embodiments, the resilient core 146 is the same as resilient core 170. As best seen in FIG. 4, the rear battery bracket 172 has a left side and a right side, with the bushing 166 held between the left side and the right side, such as with a bolt 174. As is discussed further below, the coupling structure 152 couples the rear wall 118 of the battery case 114 to the frame rail 102 at an effective coupling point below the frame rail 102 and, in some embodiments, proximate the bottom 122 of the battery case 114 (e.g., at the location of bolt 174).

The support structure 100 integrates the battery case 114 as part of the frame structure in combination with the frame rails 102, the coupling structure 130, and the coupling structure 152. In this sense, the support structure 100 takes advantage of an already existing structure in the battery case 114, but incorporates the battery case 114 into the frame in an at least partially isolated way through use of bushings 142 and bushings 166. This can reduce the material required in the frame rails 102 (e.g., in that the middle section 110 has a reduced height) and therefore can reduce the overall weight, while still accommodating a larger battery (or batteries) that allow the vehicle to have a longer range when powered by the battery or batteries. The bottom 122 of the battery case 114 provides added structural integrity to the frame rails 102, such that the frame rails 102 are not carrying all of the loads placed on the vehicle in use.

More specifically, the support structure 100 described herein helps limit the forces from the frame rails 102 in vertical bending, lateral bending, and torsional bending, thus helping to prevent distortion of any battery cells supported within the battery case 114. This effect is in part due to the lower structure mount location, with the bolts 150 and the bolts 174 being below the frame rails 102 and near the bottom 122, and in part due to the resilient bushings 142, 166. In some embodiments, a vertical bending force may be placed on the frame rails 102 at the middle section 110 (such as loading a trailer onto a truck cab having the support structure 100). This vertical bending results in an angular delta between the second ends 136 and the second ends 158 about the Y-axis (as labeled in FIG. 1). The vertical bending is, however, translated into longitudinal displacement at the bushings 142 and the bushings 166. The lower mounting location produces a moment arm that reacts to the load, reducing the amount of force on the battery case 114. In this load environment, there are effectively two springs: one being the frame rails 102 and the other being the longitudinal load carried through the bottom 122 and the bushings 142, 166, plus the lever arm resulting from the mounting distance of bolts 150 and bolts 174 below the frame rails 102. Because the top 124 of the battery case 114 may not be as strong as the bottom 122, the support structure 100 described above, along with the lower mounting locations provided by the coupling structure 130 and the coupling structure 152, helps control the loading on the battery case 114 and the bottom 122 carries a portion of the vertical bending forces as shear forces along the X-axis. Further, the bushings 142 and the bushings 166 limit the transfer of vertical forces as a bending moment (such as would be the case if the battery case 114 was mounted to the frame rails 102 directly, which would pass a bending moment directly to the battery case 114). With the bolts 150 mounted within bushings 142 and the bolts 174 mounted within bushings 166, the bending forces transmitted to the battery case 114 are limited (with forces being transmitted longitudinally along the bottom 122 of the battery case 114).

The support structure 100 also helps control torsional bending forces on the vehicle (and thus the frame rails 102 and the battery case 114). With a torsional force applied to the support structure 100, the torsional bending results in an angular delta between the second ends 136 and the second ends 158 about the X-axis, with both a lateral component and a vertical component. This torsional bending is translated into lateral displacement at the bushings 142 and the bushings 166, due to the lower mounting point provided by the coupling structure 130 and the coupling structure 152. The lateral isolator rate is amplified by the mounting distance of bolts 150 and bolts 174 (within the coupling structure 130 and the coupling structure 152) below the frame rails 102. There is also a vertical displacement component in the torsional bending that is carried by the bushings 142 and the bushings 166. The vertical isolator rate is amplified by the lateral distance along the Y-axis of the bushings 142 and the bushings 166 spaced away from the frame rails 102. With this support structure 100, in torsion, the forces on one side are increased and on the other side are decreased. In other words, the torsional forces apply a lifting effect on a front end of the frame rail 102 as the back end of the frame rail 102 experiences a downward force. On the other frame rail 102, the front end will experience a downward force and the back end will experience an upward force. The resilient cores 146 and the resilient cores 170 provide strain relief in this circumstance of torsional bending.

The support structure 100 may also be subjected to lateral bending forces (such as when the vehicle is turning). This lateral bending results in an angular delta between the second ends 136 and the second ends 158 about the Z-axis. The lateral bending is then translated into longitudinal displacement at the bushings 142 and the bushings 166, and the longitudinal isolator rate is amplified by the lateral spacing of the bushings 142 and the bushings 166 from the frame rails 102. Using this configuration, the support structure 100 can effectively support a larger capacity battery while also limiting the overall weight of the frame structure and while protecting the battery case (and thus the battery cells) from loads and forces experienced by the frame structure in normal use (e.g., accelerating, turning, stopping, and the like).

The support structure 100 is configured so that, even with the battery case 114 removed from the rails 102 (such as might be needed for maintenance or service), a vehicle can otherwise still be adequately supported by the rails 102. For such maintenance or service, the battery case 114 can be removed from the frame rails 102 (as shown in FIG. 5), such as by removing bolts 150 and bolts 174, and then lowered away from the frame rails 102 (in some embodiments, the battery case 114 could be supported and the frame rails 102 could be raised, to limit the movement of the battery case 114).

During testing, it was found that the power spectral density (“PSD”) versus frequency of a battery support structure as described herein (e.g., support structure 100), measured at different measurement points, was lower when utilizing a relatively softer mounting assembly, e.g., as defined by the coupling structure 130 (e.g., with bushings 142 and resilient cores 146) and the coupling structure 152 (with bushings 166 and resilient cores 170) as compared to a more rigid or harder mounting assembly defined by a similar combination of components. The use of a relatively softer mounting assembly was found to enhance the distribution of forces such that those forces were more easily maintained below threshold levels. In relation to material/component properties, hardness can be determined using a test such as ASTM E18-22, among others; tensile strength can be determined using a test such as ASTM E8, among others; and modulus of elasticity can be determined using a test such as ASTM E111, among others.

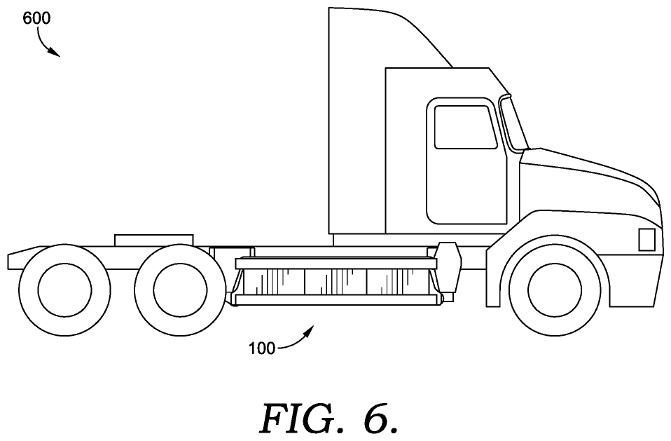

Looking now at FIG. 6, a vehicle 600 that includes the support structure 100 of FIG. 1 (among other possible support structures) is shown, in accordance with embodiments of the present disclosure. The vehicle 600 shown in FIG. 6 is depicted as a freight tractor (e.g., that forms part of a tractor-trailer). In embodiments, the vehicle 600 can be combustion-powered, electric-powered, hybrid combustion-electric-powered, or powered using another type of powertrain. The support structure 100 is suitable for supporting a battery case that holds batteries used to power electrical components and systems of the vehicle 600.

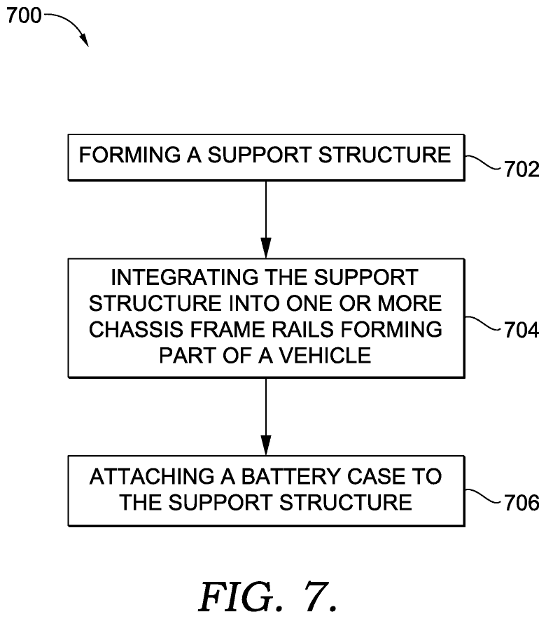

FIG. 7 is a block diagram of a method 700 of integrating a support structure, e.g., such as the support structure 100 shown in FIG. 1, into a vehicle, e.g., such as the vehicle 600 shown in FIG. 6. The method 700 includes blocks 702-706, but is not limited to this combination of elements, or the order depicted. In block 702, the method 700 includes forming a support structure, e.g., such as the support structure 100 shown in FIG. 1. In block 704, the method 700 includes integrating the support structure into one or more chassis frame rails, e.g., frame rails 102 shown in FIG. 1, forming part of the vehicle. In block 706, the method 700 includes attaching a battery case, e.g., such as the battery case 114 shown in FIG. 1, to the support structure.

In embodiments, a method of manufacturing a support structure for a battery case is provided. The method includes forming and/or assembling the support structure such that it can be attached to a battery case, e.g., configured to support one or more vehicle batteries, and such that it can be attached to frame rails of a vehicle.

In embodiments, a method of integrating a support structure for a battery case into a vehicle is provided. The method includes forming and/or assembling a support structure; attaching the support structure to a battery case; and attaching the support structure to frame rails of a vehicle, e.g., that is at least partially electrically powered.

In embodiments, a support structure can be adapted to attach and/or support a battery case above the frame rails of a vehicle.

In embodiments, a support structure can be adapted to attach and/or support a battery case laterally on the sides of frame rails of a vehicle.

In embodiments, a support structure can be adapted to attach and/or support a battery case below or under, e.g., substantially fully under, frame rails of a vehicle.

The support structures herein can be manufactured as a single, solid, unified structure (e.g., being formed of metal, metal alloy, or non-metallic materials), or can be assembled from multiple structures. In embodiments, components of the support structures described herein can be cast (e.g., through metal casting), extruded (e.g., through metal extrusion), can be formed using additive manufacturing (e.g., three-dimensional printing), can be formed using subtractive manufacturing (e.g., machining such as electrical discharge machining “EDM”, boring, drilling, cutting, sanding, and the like), or can be formed or assembled using other manufacturing methodologies. In embodiments, components of the support structures described herein can be attached together using different attachment methodologies. For example, attachments, e.g., including those that are fixed or reversible, can be provided through welding, adhering, or through use of fasteners (e.g., bolts, screws, rivets, clips, pins, nuts, washers, and the like), and/or using other mechanical attachment methods suitable for coupling structures together, e.g., interlocking structures, locking mechanisms, or frictional engagement, among others.

Clause 1. A support structure for an electric vehicle, comprising: a pair of elongated frame rails spaced apart from one another, each frame rail having a front end and a rear end; a pair of front rail brackets, each front rail bracket having a first end coupled to a frame rail and a second end extending downwardly therefrom; a pair of rear rail brackets, spaced apart from the front rail brackets, each rear rail bracket having a first end coupled to a frame rail rearward of the front rail brackets and a second end extending downwardly therefrom; and at least one battery case having at least a front wall, a rear wall and a bottom, the battery case coupled to the front rail brackets and the rear rail brackets, the battery case being coupled to the frame rails proximate to the respective second ends of the front rail brackets and the second ends of the rear rail brackets, such that the battery case extends below the frame rails, and is coupled to the frame rails, through the front rail brackets and the rear rail brackets, at a point below the frame rails.

Clause 2. The support structure of clause 1, further comprising: a pair of front battery brackets coupled to the front wall of the battery case; a pair of rear battery brackets coupled to the rear wall of the battery case; a pair of front bushings, each front bushing coupled to and extending between a respective second end of a front rail bracket and a respective front battery bracket; and a pair of rear bushings, each rear bushing coupled to and extending between a respective second end of a rear rail bracket and a respective rear battery bracket.

Clause 3. The support structure of clause 1 or 2, wherein the front bushings and the rear bushings have a resilient inner core.

Clause 4. The support structure of any of clauses 1-3, wherein each frame rail forms a vertical plane, and wherein at least a portion of the front bushings and the rear bushings are spaced outwardly from the vertical plane formed by the frame rails.

Clause 5. The support structure of any of clauses 1-4, wherein each frame rail is an elongated member having a height, and wherein the height of each frame rail is less in the portion of each frame rail above the battery case, and more in the portion of each frame rail distal from the battery case.

Clause 6. The support structure of any of clauses 1-5, wherein each frame rail has a front section, a middle section and a rear section, wherein the middle section is directly above the battery case, and wherein the front and rear sections have a greater height than the middle section.

Clause 7. The support structure of any of clauses 1-6, further comprising a plurality of cross supports coupled to and extending between the frame rails.

Clause 8. The support structure of any of clauses 1-7, wherein the battery case comprises a plurality of battery packs fixedly coupled to one another.

Clause 9. A frame rail structure for an electric vehicle, comprising: a pair of elongated frame rails spaced apart from one another, each frame rail having a front end and a rear end; at least one battery case below the frame rails, the battery case having at least a front wall, a rear wall and a bottom; a first coupling structure, extending between the front wall of the battery case and the pair of elongated frame rails; and a second coupling structure, extending between the rear wall of the battery case and the pair of elongated frame rails, wherein the first coupling structure and the second coupling structure secure the battery case below the frame rails.

Clause 10. The frame rail structure of clause 9, wherein the first coupling structure comprises: a pair of spaced apart front rail brackets, each having a first end coupled to a respective frame rail and a second end extending downwardly therefrom, a pair of front battery brackets coupled to the front wall of the battery case and extending forwardly therefrom; and a pair of front bushings, each front bushing coupled to and extending between a respective second end of a front rail bracket and a respective front battery bracket, wherein the front bushings establish a mounting point for the battery case to the frame rail below the frame rail.

Clause 11. The frame rail structure of clause 9 or 10, wherein each front bushing has a resilient inner core.

Clause 12. The frame rail structure of any of clauses 9-11, wherein the second coupling structure comprises: a pair of spaced apart rear rail brackets, each having a first end coupled to a respective frame rail and a second end extending downwardly therefrom, a pair of rear battery brackets coupled to the rear wall of the battery case and extending rearwardly therefrom; and a pair of rear bushings, each rear bushing coupled to and extending between a respective second end of a rear rail bracket and a respective rear battery bracket, wherein the rear bushings establish a mounting point for the battery case to the frame rail below the frame rail.

Clause 13. The frame rail structure of any of clauses 9-12, wherein each rear bushing has a resilient inner core.

Clause 14. The frame rail structure of any of clauses 9-13, wherein at least one of the front bushings or the rear bushings are molded to provide greater resiliency in one direction.

Clause 15. The frame rail structure of any of clauses 9-14, wherein each frame rail is an elongated member having a height, and wherein the height of each frame rail is less in the portion of each frame rail above the battery case, and wherein the height of the frame rail is more in the portion of each frame rail extending forwardly and rearwardly from the battery case.

Clause 16. An integrated frame rail and battery case structure for an electric vehicle, the structure comprising: a pair of elongated frame rails spaced apart from one another, each frame rail having a front end and a rear end; at least one battery case below the frame rails, the battery case having at least a front wall, a rear wall and a bottom; a first coupling structure, extending between the front wall of the battery case and the pair of elongated frame rails, the first coupling structure including a first bushing below one frame rail and a second bushing below the other frame rail; and a second coupling structure, extending between the rear wall of the battery case and the pair of elongated frame rails, the second coupling structure including a third bushing below one frame rail and a fourth bushing below the other frame rail, wherein the first bushing, the second bushing, the third bushing and the fourth bushing provide a four-point mounting system to couple the battery case to the frame rails below the frame rails.

Clause 17. The structure of clause 16, wherein the first coupling structure comprises: a pair of spaced apart front rail brackets, each having a first end coupled to a respective frame rail and a second end extending downwardly therefrom, and a pair of front battery brackets coupled to the front wall of the battery case and extending forwardly therefrom; and wherein the first bushing is coupled between a second end of a front rail bracket and a front battery bracket, the second bushing is coupled between a second end of a front rail bracket and a front battery bracket, and wherein the first bushing and the second bushing have a resilient inner core.

Clause 18. The structure of clause 16 or 17, wherein the second coupling structure comprises: a pair of spaced apart rear rail brackets, each having a first end coupled to a respective frame rail and a second end extending downwardly therefrom, and a pair of rear battery brackets coupled to the rear wall of the battery case and extending rearwardly therefrom; and wherein the third bushing is coupled between a second end of a rear rail bracket and a rear battery bracket, the fourth bushing is coupled between a second end of a rear rail bracket and a rear battery bracket, and wherein the third bushing and the fourth bushing have a resilient inner core.

Clause 19. The structure of any of clauses 16-18, further comprising a cross-member extending between and fixedly coupled to the front rail brackets.

Clause 20 The structure of any of clauses 16-19, further comprising a cross-member extending between and fixedly coupled to the rear rail brackets.

Clause 21. The support structure of any of clauses 1-20 incorporated into a vehicle assembly.

Clause 22. A vehicle comprising the support structure of any of clauses 1-20.

Clause 23. The vehicle of clause 22, wherein the vehicle is: electrically-powered, combustion-powered, or hybrid combustion-electric-powered.

Clause 24. A method of manufacturing a support structure according to any of clauses 1-20.

Clause 25 A method of integrating a support structure according to any of clauses 1-20 into a vehicle.

Clause 26. A method of using a support structure according to any of clauses 1-20.

The embodiments described herein can be implemented in a variety of vehicle sizes, classes, and types (e.g., light duty trucks and other passenger vehicles, medium duty trucks, and heavy duty or commercial trucks, as well as other equipment and machines including buses, trams, carts, construction equipment, and the like). In addition, the subject matter of this disclosure can be used with internal combustion engine (“ICE”) vehicles, electric vehicles (“EV”), battery electric vehicles (“BEV”); hybrid electric vehicles (“HEV”), plug-in electric vehicles (“PHEV”), and with fuel-cell electric vehicles (“FCEV”), among others.

In some embodiments, this disclosure may include the language, for example, “at least one of [element A] and [element B].” This language may refer to one or more of the elements. For example, “at least one of A and B” may refer to “A,” “B,” or “A and B.” In other words, “at least one of A and B” may refer to “at least one of A and at least one of B,” or “at least either of A or B.” In some embodiments, this disclosure may include the language, for example, “[element A], [element B], and/or [element C].” This language may refer to either of the elements or any combination thereof. In other words, “A, B, and/or C” may refer to “A,” “B,” “C,” “A and B,” “A and C,” “B and C,” or “A, B, and C.” In addition, this disclosure may use the term “and/or” which may refer to any one or combination of the associated elements. In addition, this disclosure may use the term “a” (element) or “the” (element). This language may refer to the referenced element in the singular or in the plural and is not intended to be limiting in this respect.

The subject matter of this disclosure has been described in relation to particular embodiments, which are intended in all respects to be illustrative rather than restrictive. In this sense, alternative embodiments will become apparent to those of ordinary skill in the art to which the present subject matter pertains without departing from the scope hereof. In addition, different combinations and sub-combinations of elements disclosed, as well as use and inclusion of elements not shown, are possible and contemplated as well.

1. A support structure for an electric vehicle, comprising: a pair of elongated frame rails spaced apart from one another, each frame rail having a front end and a rear end; a pair of front rail brackets, each front rail bracket having a first end coupled to a frame rail and a second end extending downwardly therefrom; a pair of rear rail brackets, spaced apart from the front rail brackets, each rear rail bracket having a first end coupled to a frame rail rearward of the front rail brackets and a second end extending downwardly therefrom; and at least one battery case having at least a front wall, a rear wall and a bottom, the battery case coupled to the front rail brackets and the rear rail brackets, the battery case being coupled to the frame rails proximate to the respective second ends of the front rail brackets and the second ends of the rear rail brackets, such that the battery case extends below the frame rails, and is coupled to the frame rails, through the front rail brackets and the rear rail brackets, at a point below the frame rails.

2. The support structure of claim 1, further comprising: a pair of front battery brackets coupled to the front wall of the battery case; a pair of rear battery brackets coupled to the rear wall of the battery case; a pair of front bushings, each front bushing coupled to and extending between a respective second end of a front rail bracket and a respective front battery bracket; and a pair of rear bushings, each rear bushing coupled to and extending between a respective second end of a rear rail bracket and a respective rear battery bracket.

3. The support structure of claim 2, wherein the front bushings and the rear bushings each have a resilient inner core.

4. The support structure of claim 2, wherein each frame rail forms a vertical plane, and wherein at least a portion of the front bushings and the rear bushings are spaced outwardly from the vertical plane formed by the frame rails.

5. The support structure of claim 1, wherein each frame rail is an elongated member having a height, and wherein the height of each frame rail is less in the portion of each frame rail above the battery case, and more in the portion of each frame rail distal from the battery case.

6. The support structure of claim 1, wherein each frame rail has a front section, a middle section and a rear section, wherein the middle section is directly above the battery case, and wherein the front and rear sections each have a greater height than the middle section.

7. The support structure of claim 1, further comprising a plurality of cross supports coupled to and extending between the pair of elongated frame rails.

8. The support structure of claim 1, wherein the battery case comprises a plurality of battery packs fixedly coupled to one another.

9. A frame rail structure for an electric vehicle, comprising: a pair of elongated frame rails spaced apart from one another, each frame rail having a front end and a rear end; at least one battery case below the frame rails, the battery case having at least a front wall, a rear wall and a bottom; a first coupling structure, extending between the front wall of the battery case and the pair of elongated frame rails; and a second coupling structure, extending between the rear wall of the battery case and the pair of elongated frame rails, wherein the first coupling structure and the second coupling structure secure the battery case below the frame rails.

10. The frame rail structure of claim 9, wherein the first coupling structure comprises: a pair of spaced apart front rail brackets, each having a first end coupled to a respective frame rail and a second end extending downwardly therefrom; a pair of front battery brackets coupled to the front wall of the battery case and extending forwardly therefrom; and a pair of front bushings, each front bushing coupled to and extending between a respective second end of a front rail bracket and a respective front battery bracket, wherein the front bushings establish a mounting point for the battery case to the frame rail below the frame rail.

11. The frame rail structure of claim 10, wherein each front bushing has a resilient inner core.

12. The frame rail structure of claim 9, wherein the second coupling structure comprises: a pair of spaced apart rear rail brackets, each having a first end coupled to a respective frame rail and a second end extending downwardly therefrom; a pair of rear battery brackets coupled to the rear wall of the battery case and extending rearwardly therefrom; and a pair of rear bushings, each rear bushing coupled to and extending between a respective second end of a rear rail bracket and a respective rear battery bracket, wherein the rear bushings establish a mounting point for the battery case to the frame rail below the frame rail.

13. The frame rail structure of claim 12, wherein each rear bushing has a resilient inner core.

14. The frame rail structure of claim 12, wherein the rear bushings are molded to provide greater resiliency in one direction.

15. The frame rail structure of claim 9, wherein each frame rail is an elongated member having a height, and wherein the height of each frame rail is less in the portion of each frame rail above the battery case, and wherein the height of the frame rail is more in the portion of each frame rail extending forwardly and rearwardly from the battery case.

16. An integrated frame rail and battery case structure for an electric vehicle, the structure comprising: a pair of elongated frame rails spaced apart from one another, each frame rail having a front end and a rear end; at least one battery case below the frame rails, the battery case having at least a front wall, a rear wall and a bottom; a first coupling structure, extending between the front wall of the battery case and the pair of elongated frame rails, the first coupling structure including a first bushing below one frame rail and a second bushing below the other frame rail; and a second coupling structure, extending between the rear wall of the battery case and the pair of elongated frame rails, the second coupling structure including a third bushing below one frame rail and a fourth bushing below the other frame rail, wherein the first bushing, the second bushing, the third bushing and the fourth bushing provide a four-point mounting system to couple the battery case to the frame rails below the frame rails.

17. The structure of claim 16, wherein the first coupling structure comprises: a pair of spaced apart front rail brackets, each having a first end coupled to a respective frame rail and a second end extending downwardly therefrom, and a pair of front battery brackets coupled to the front wall of the battery case and extending forwardly therefrom; and wherein the first bushing is coupled between a second end of a front rail bracket and a front battery bracket, the second bushing is coupled between a second end of a front rail bracket and a front battery bracket, and wherein the first bushing and the second bushing have a resilient inner core.

18. The structure of claim 16, wherein the second coupling structure comprises: a pair of spaced apart rear rail brackets, each having a first end coupled to a respective frame rail and a second end extending downwardly therefrom, and a pair of rear battery brackets coupled to the rear wall of the battery case and extending rearwardly therefrom; and wherein the third bushing is coupled between a second end of a rear rail bracket and a rear battery bracket, the fourth bushing is coupled between a second end of a rear rail bracket and a rear battery bracket, and wherein the third bushing and the fourth bushing have a resilient inner core.

19. The structure of claim 17, further comprising a cross-member extending between and fixedly coupled to the front rail brackets.

20. The structure of claim 18, further comprising a cross-member extending between and fixedly coupled to the rear rail brackets.
